(19) United States
(12) Patent Application Publication
(10) Pub. No.: US 2008/0023403 A1
(43) Pub. Date: Jan. 31, 2008

(54) METHODS FOR REMOVING INSOLUBLE LEAD FROM WATER

(76) Inventors: James Rulon Young Rawson, Clifton Park, NY (US); Shane Gernand, Glenville, NY (US); Brian Moore, Mechanicville, NY (US)

Correspondence Address: GENERAL ELECTRIC CO.;GLOBAL PATENT OPERATION, 187 Danbury Road, Suite 204, Wilton, CT, 06897-4122, US

(21) Appl. No.: 11/780,678

(22) Filed: Jul. 20, 2007

Related U.S. Application Data
(60) Provisional application No. 60/834,237, filed on Jul. 28, 2006.

(51) Int. Cl. C02F 1/42

(52) U.S. Cl. 210/665; 210/688

(57) ABSTRACT

A method for removing negatively charged insoluble lead from water including contacting water containing negatively charged insoluble lead with an adsorption medium having a positive charge. The treated water has reduced levels of insoluble lead.

### CROSS REFERENCE TO RELATED APPLICATION

This application claims the benefit of U.S. Provisional Application No. 60/834,237 filed Jul. 28, 2006, which is hereby incorporated by reference in its entirety.

### FIELD OF THE INVENTION

This invention relates to methods and systems for purifying water and more particularly, to the removal of insoluble lead from water.

### BACKGROUND OF THE INVENTION

Lead is often released into drinking water distribution systems from lead pipes, brass fixtures and lead-based solders. Lead can also originate in drinking water from natural sources, such as minerals found in aquifers. The U.S. Environmental Protection Agency (USEPA) has set an action level for lead in drinking water at 15 micrograms/L (μg/L). When drinking water systems are devoid of materials that contain lead, this concentration of lead can be easily achieved; however, when there is lead in a drinking water distribution system or in the source water, the total concentration of lead in the drinking water can exceed the USEPA action level for lead.

As much as 40 to 60% of the lead in drinking water may be insoluble and exist as colloidal or particulate matter typically ranging in size from 0.1 to 1.5 microns. Drinking water is typically characterized by pH values ranging from 6.5 to 8.5 and Eh values from 0.0 to 1.0 volts. Within this range of pH and Eh values, insoluble lead exists as alkaline lead carbonate (hydrocerussite or trilead carbonate dihydroxide —Pb₃(CO₃)₂(OH)₂ and/or similar types of lead species).

In the past, it was generally not recognized that a substantial quantity of insoluble colloidal lead had to be removed from drinking water to meet the USEPA advisory concentration for lead. Therefore, treatment systems were designed to remove primarily soluble lead through the use of a lead adsorbent media consisting of either a cationic ceramic matrix or weak cation exchange resins, both of which are able to adsorb soluble lead in drinking water.

In general, insoluble lead particles can be removed by size exclusion, which is commonly referred to as mechanical filtration, provided the filter has pores small enough to exclude the insoluble lead particles. The smaller the pore sizes in the filter, the better is the separation efficiency; however, high pressures are needed to maintain flow through the filter. In the case of residential water purification, the mechanical filtration of insoluble lead cannot be done at pressures higher than those existing at the point of entry (POE) to the house, typically 60 psi. Moreover, for the case of point of use (POU) lead pitcher filters, there is no pressure driving force through the filter except for gravity, and so high efficiency mechanical filtration methods cannot be used.

Improved processes for the removal of insoluble lead in water are needed.

### SUMMARY OF THE INVENTION

In one embodiment, a method is described for removing negatively charged insoluble lead from water, said method comprising contacting water containing negatively charged insoluble lead with an adsorption medium having a positive charge.

The various embodiments provide improved methods for removing insoluble lead from water.

### BRIEF DESCRIPTION OF DRAWING

FIG. 1 is a graph showing insoluble lead removal as a function of the volume of water.

### DETAILED DESCRIPTION OF THE INVENTION

The singular forms “a,” “an” and “the” include plural referents unless the context clearly dictates otherwise. The endpoints of all ranges reciting the same characteristic are independently combinable and inclusive of the recited endpoint. All references are incorporated herein by reference.

The modifier “about” used in connection with a quantity is inclusive of the stated value and has the meaning dictated by the context (e.g., includes the tolerance ranges associated with measurement of the particular quantity).

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

In one embodiment, a method for removing negatively charged insoluble lead from water, said method comprising contacting water containing negatively charged insoluble lead with an adsorption medium having a positive charge.

Insoluble lead typically exists within a drinking water source as negatively charged colloidal species consisting of alkaline lead carbonate, such as hydrocerussite or trilead carbonate dihydroxide (Pb₃(CO₃)₂(OH)₂) and/or similar types of lead species. In drinking water, these types of insoluble colloids develop a surface charge that causes the insoluble colloids to repel one another and to remain suspended in the water. These electrostatic charges impart a net negative charge or negative Zeta potential to the colloidal materials. At high pH, colloids are typically negatively charged, while at lower pH's they are often positively charged. The pH value of drinking water is generally in the range of from about 6.5 to about 8.5 and the net charge or Zeta potential of the insoluble colloidal lead is negative in this range. In the pH range of about 6.5 to about 8.5, the measured Zeta potential or charge of the colloidal hydrocerussite or trilead carbonate dihydroxide (Pb₃(CO₃)₂(OH)₂) is typically in the range of −19 mV to −17 mV, respectively.

The water may be drinking water. In one embodiment, the water has a pH value in the range of from about 6.5 to about 8.5. In another embodiment, the water has an Eh value in the range of from about 0.0 to about 1.0 volts. In another embodiment, the water has a pH value in the range of from about 6.5 to about 8.5 and an Eh value in the range of from about 0.0 to about 1.0 volts

The water containing insoluble lead, such as colloidal hydrocerussite or trilead carbonate dihydroxide (Pb₃(CO₃)₂(OH)₂), can have a range of insoluble lead content and any concentration of negatively charged insoluble lead can be treated. In one embodiment, the water has up to several hundred micrograms per liter of negatively charged insoluble lead as hydrocerussite or trilead carbonate dihydroxide (Pb₃(CO₃)₂(OH)₂). In another embodiment, the water contains from about 15 to about 500 micrograms per liter of the negatively charged insoluble lead.

The adsorption medium may be any type of conventional adsorbent that has a positive charge to adsorb and remove the negatively charged insoluble lead. In one embodiment, the adsorption medium has a positive charge in the pH range of from about 6.5 to about 8.5. In one embodiment, the adsorption medium comprises a quaternary ammonium cation polymer, a strong anionic exchange resin or activated alumina, such as boehmite and/or other similar types of materials.

In one embodiment, the adsorption medium has an isoelectric point (IEP) greater than a pH of about 8.5. The isoelectric point or point of zero charge is the pH at which colloids are neutrally charged or where the charge on the colloids changes from positive to negative. The isoelectric point for colloidal lead can vary depending on the type of colloidal material. In one embodiment, the isoelectric point for colloidal lead in the form of hydrocerussite or trilead carbonate dihydroxide is at a pH of less than about 6.5. The isoelectric point of activated alumina particles, such as boehmite, is at a pH of from about 8.5 to about 9.1.

The adsorption medium is used in any amount sufficient for absorbing negatively charged insoluble lead from water. In one embodiment, the amount of adsorption medium is present from about 1 to about 100 percent by weight based on the weight of the water. In another embodiment, the amount of adsorption medium is from about 5 to about 60 percent by weight based on the weight of the water. In another embodiment, the amount of adsorption medium is from about 10 to about 50 percent by weight based on the weight of the water.

The adsorption medium contacts the water containing negatively charged insoluble lead in any conventional manner. In one embodiment, the adsorption medium is mixed with the water and then the adsorption medium is separated from the water. In another embodiment, the adsorption medium is contained within a separation system. The water enters the separation system, contacts the adsorption medium and exits the separation system leaving the adsorption medium in the separation system. In another embodiment, the adsorption medium is contained within a filter cartridge. The water passes through the filter cartridge and the adsorption medium remains within the filter cartridge.

In one embodiment, the adsorption medium and water containing negatively charged insoluble lead, in the form of hydrocerussite or trilead carbonate dihydroxide, are mixed together. In one embodiment, the water and adsorption medium are mixed in a mixer, which may be any type of conventional mixer. In one embodiment, the mixer is mixed from about 2 to about 1000 revolutions/second. In another embodiment, the mixer is mixed from about 50 to about 500 revolutions/second. In another embodiment, the mixer is mixed from about 100 to about 450 revolutions/second. The mixture is blended for a period of time to intimately disperse and contact each particle of the adsorbent with the water that contains lead in the form of hydrocerussite or trilead carbonate dihydroxide. In one embodiment, the mixture is blended from about 1 second to about 1 hour. In another embodiment, the mixture is blended from about 30 seconds to about 30 minutes. In another embodiment, the mixture is blended from about 1 minute to about 20 minutes.

The treated water is isolated from the adsorption medium in any conventional manner. In one embodiment, the adsorption medium is separated from the water in a separator, such as a clarifier, settler, hydrocyclone or a centrifuge. In another embodiment, the adsorption medium is filtered out of the water.

In another embodiment, the adsorption medium is contained within a filter cartridge. The filter cartridge contains one or more types of media including the adsorption medium. In one embodiment, the adsorption medium may be contained in a support matrix. The support matrix may be woven synthetic polymeric material and/or a carbon material. In one embodiment, the filter cartridge is coupled to a water distribution system for removing negatively charged insoluble lead in the form of hydrocerussite or trilead carbonate dihydroxide from water supplied by the water distribution system.

The treated water has a reduced concentration of negatively charged insoluble lead. The actual amount of residual insoluble lead will vary depending on the starting amount. In one embodiment, the treated water has no more than about 15 micrograms/L (μg/L) of negatively charged insoluble lead. In another embodiment, the treated water has from about 0 micrograms/L to 15 micrograms/L of negatively charged insoluble lead.

In order that those skilled in the art will be better able to practice the present disclosure, the following examples are given by way of illustration and not by way of limitation.

### EXAMPLES

### Example 1

Trilead carbonate dihydroxide was added to drinking water having a pH of about 8.5 to form a negatively charged insoluble lead suspension concentration of 2300 micrograms per liter of water. The water was passed through a filter containing 100 mg of boehmite at a flow rate of 33 ml/min. The concentration of total lead in the filtrate or the effluent was measured by ICP/MS to determine the ability of the boehmite to remove insoluble alkaline lead carbonate. Table 1 shows the lead removal and amounts of boehmite used.

TABLE 1

| Influent Pb | | | Effluent Pb | |
|---|---|---|---|---|
| concentration | | Cumulative | concentration | Percent Pb |
| (ug/L) | Pb Type | Volume (L) | (ug/L) | Removed |
| 2300 | Trilead | 0.253 | 12.9 | 99.994 |
| 2300 | carbonate | 0.511 | 11.5 | 99.995 |
| 2300 | dihydroxide | 0.769 | 11.1 | 99.995 |
| 2300 | | 1.026 | 11.7 | 99.995 |
| 2300 | | 1.29 | 12.3 | 99.995 |
| 2300 | | 1.547 | 12.3 | 99.995 |
| 2300 | | 1.829 | 14.4 | 99.994 |
| 2300 | | 2.106 | 15.1 | 99.993 |
| 2300 | | 2.378 | 17.5 | 99.992 |
| 2300 | | 2.677 | 20.0 | 99.991 |
| 2300 | | 2.972 | 22.8 | 99.990 |
| 2300 | | 3.268 | 26.1 | 99.989 |
| 2300 | | 3.565 | 29.8 | 99.987 |
| 2300 | | 3.865 | 56.2 | 99.976 |

The boehmite removed greater than 99% of the influent insoluble lead.

### Example 2

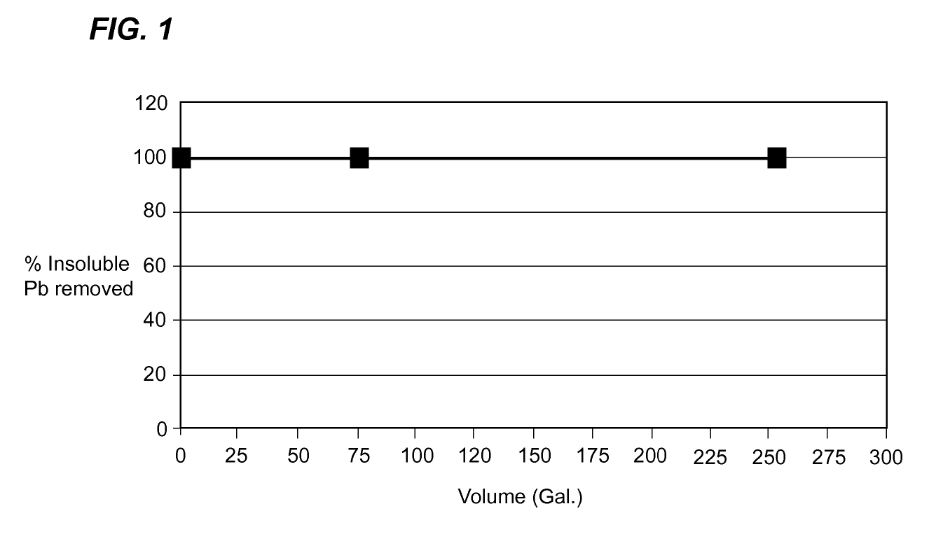

A drinking water sample having a pH of about 8.5 and containing 100 micrograms per liter of soluble lead and 50 micrograms per liter of negatively charged insoluble lead in the form of trilead carbonate dihydroxide was passed through a filter containing 3.1 g of boehmite and a commercially available medium to remove the soluble lead (ATS from Engelhard) at an initial flow rate of 0.61 gpm. The concentration of insoluble lead in the filtrate or the effluent was measured by ICP/MS to determine the ability of the boehmite to remove insoluble alkaline lead carbonate. FIG. 1 shows the percent insoluble lead removal for the volume of water for this example, FIG. 1 shows 100% insoluble lead removal.

While typical embodiments have been set forth for the purpose of illustration, the foregoing descriptions should not be deemed to be a limitation on the scope herein. Accordingly, various modifications, adaptations and alternatives may occur to one skilled in the art without departing from the spirit and scope herein.

Having described the Invention, that which is claimed is:

1. A method for removing negatively charged insoluble lead from water, said method comprising contacting water containing negatively charged insoluble lead with an adsorption medium having a positive charge.

2. The method of claim 1 wherein the adsorption medium has a positive charge throughout a pH ranging from about 6.5 to about 8.5.

3. The method of claim 1 wherein the insoluble lead is alkaline lead carbonate.

4. The method of claim 3 wherein the alkaline lead carbonate is colloidal hydrocerussite or trilead carbonate dihydroxide.

5. The method of claim 1 wherein the water has a pH ranging from about 6.5 to about 8.5.

6. The method of claim 1 wherein the water contains from about 15 to about 500 micrograms per liter of negatively charged insoluble lead.

7. The method of claim 1 wherein the Zeta potential of the adsorption medium is positive throughout a pH ranging from about 6.5 to about 8.5.

8. The method of claim 1 wherein the adsorption medium has an isoelectric point of greater than a pH of about 8.5.

9. The method of claim 1 wherein the adsorption medium is a quaternary ammonium cation polymer, activated alumina or a strong anionic exchange resin.

10. The method of claim 9 wherein the activated alumina is boehmite.

11. The method of claim 1 wherein the adsorption medium is present from about 1 to about 100 percent by weight based on the weight of the water.

12. The method of claim 11 wherein the adsorption medium is present from about 5 to about 60 percent by weight based on the weight of the water.

13. The method of claim 1 wherein the adsorption medium is mixed with the water.

14. The method of claim 13 wherein the adsorption medium and water are mixed from about 1 second to about 1 hour.

15. The method of claim 13 wherein the adsorption medium and water are mixed in a mixer.

16. The method of claim 15 wherein the adsorption medium is separated from the water in a separator.

17. The method of claim 16 wherein the separator is a clarifer, settler, hydrocyclone or centrifuge.

18. The method of claim 1 wherein the adsorption medium is contained within a separation system, said water enters the separation system to contact the adsorption medium.

19. The method of claim 1 wherein the separation system is a filter cartridge.
